(19) United States
(12) Patent Application Publication
(10) Pub. No.: US 2009/0207032 A1
(43) Pub. Date: Aug. 20, 2009

(54) Method to detect the level of granular material in a bin

(76) Inventors: Gary E. Gunthorpe, Calgary (CA); Ken Jackson, Saskatchewan (CA); Bradly Murdoch, Calgary (CA)

Correspondence Address: NIXON & VANDERHYE, PC, 901 NORTH GLEBE ROAD, 11TH FLOOR, ARLINGTON, VA, 22203, US

(21) Appl. No.: 12/071,161

(22) Filed: Feb. 15, 2008

(51) Int. Cl. G01F 23/00; G08B 21/00

(52) U.S. Cl. 340/617

(57) ABSTRACT

Apparatus and systems for a novel apparatus for determining the level of granular material in a bin. The invention comprises methods and apparatus to detect when a sensor is covered by granular material.

A system is described that comprises; a metallic pin, devices and circuits to measure the electrical capacitance of the pin, devices and circuits to detect changes in the capacitance, and devices and circuits to announce the change.

The invention is applicable to an agriculture application whereby an operator is alerted to a near full bin in time to stop the machinery used to fill the bin before it overflows.

### FIELD OF THE INVENTION

The present invention relates to an apparatus for detecting and announcing when a stortage bin becomes full. An agricultural operation stores the grains it produces in weather proof bins. When the bins are being filled the operator normally monitors the amount in the bin visually so that the bin does not overflow. The present invention, provides a remote indication to the operator when the bin is nearing full.

### BACKGROUND

It is known that if a storage bin overflows while it is being filled, the filling machinery can become jammed and damaged. Also some of the overflowed granular material can be spoilt or lost. A considerable amount of time is required to fill a bin and the operator must remain diligent for the duration.

The present invention allows the operator to rest or work at other tasks, as the bin fills. When a level is reached, that allows time for the operator to return to the bin, a radio signal is sent to a pager like device, causing an audible, tactile and visual alarm to occur. Also when a critical level is reached the invention sends another signal, which causes a second audible, tactile and visual alarm to occur. The operator then shuts the filling machinery off.

Capacitive sensors are used extensively for level measurement and proximity detection. A proximity detector typically determines if materials are near the sensor by comparing the measured capacitance to the predetermined threshold. If the capacitance varies due to environmental changes, this method give false positive or negative detections.

It is known that circuits are available which sense the dramatic change in capacitance when a human finger is placed on a touch pad as taught by Phillip; Harald U.S. Pat. No. 6.452,514. These circuits regularly zero themselves to the current capacitance, thus eliminating drift. These circuits are very low cost. It is also known that Livingston in U.S. Pat. No. 6,539,797 teaches a method of using a separate reference capacitance sensor to correct for change in dielectric of the medium being sensed and that this technique does not work to negate the effects of dust build up, thus producing an erroneous result.

### DISCLOSURE OF THE INVENTION

It is known that dust will build up on any surface inside the bin and it has been discovered, by the inventors, that using the Phillip; Harald technique eliminates the problem of dust build up and can be used to detect when a metallic probe is fully immersed in granular material vers covered in a build up of dust.

In the preferred embodiment of the invention, two metallic probes are permanently mounted through the side of the storage bin. One is located near the top of the bin and the other at an appropriate distance below the first probe. Circuits are connected to the metallic probes such that the Phillip; Harald capacitive proximity technique is implemented. A cable connects the resulting two sensors to a connector mounted near the bottom of the bin.

Further circuits are provided in an easily removable housing that can be moved from bin to bin as required. These circuits power the sensors and respond to the detected presence of granular material. This apparatus contains visual annunciation devices and a radio frequency transmitter capable of sending an encoded signal to a remote portable receiver.

Further circuits are provided in a portable, pager like, housing that can be carried by an operator. This apparatus contains a radio frequency receiver capable of receiving the signals sent from the above apparatus connected to the sensor via the cable. It also contains logic and circuits that decodes the signal and visual, audible and tactile annunciation devices to inform the operator of the event of the granular material covering either sensor.

### BRIEF DESCRIPTION OF THE DRAWINGS

FIG. 1 is a fragmentary, vertical section of a storage bin with the level sensors, controller/transmitter and portable/receiver of this invention mounted thereon;

FIG. 2 is a block diagram of a prototypical system. It shows the major blocks that are required to realize the Invention;

FIG. 3 is a mechanical drawing of fragmentary, sections of the preferred embodiment of the sensor;

FIG. 4 is a data flow diagram for a prototypical sensor apparatus. It shows the major blocks that are required to realize the Invention:

FIG. 5 is a data flow diagram for a prototypical controller/transmitter apparatus. It shows the major blocks that are required to realize the Invention;

FIG. 6 is a data flow diagram for a prototypical portable receiver apparatus. It shows the major blocks that are required to realize the Invention.

### DETAILED DESCRIPTION OF THE PREFERRED EMBODIMENT

The storage bin level sensing apparatus of the present invention includes one or more capacitive sensors, connected via a common cable to a controller/transmitter which sends a radio status signal to a portable/receiver to alert an operator of a pending over fill condition.

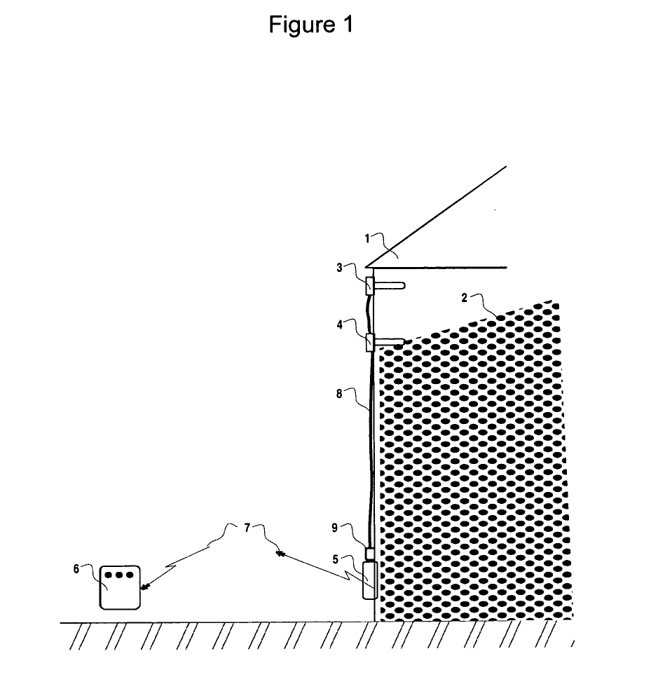

FIG. 1 describes a fragmentary, vertical section of a storage bin 1 with the level sensors 3 & 4, controller/transmitter 5 and portable/receiver 6 of this invention. In operation a plurality of sensors 3 & 4 are inserted through the wall of a storage bin 1. When the granular material 2 rises to cover the lowest sensor 4, it is detected and an electrical signal is sent via the cable 8 to a removable controller/transmitter 5. Said controller/transmitter 5 is retained by a holder 9 located at the bottom of the cable 8. The controller/transmitter 5 turns on a visual annunciator and, sends a radio signal 7 to the portable/receiver 6. The portable/receiver 6 receives the radio signal 7 and turns on visual, audible and tactile annunciators, thus alerting the operator. A similar procedure is preformed for each of the sensors 3 above the lowest one.

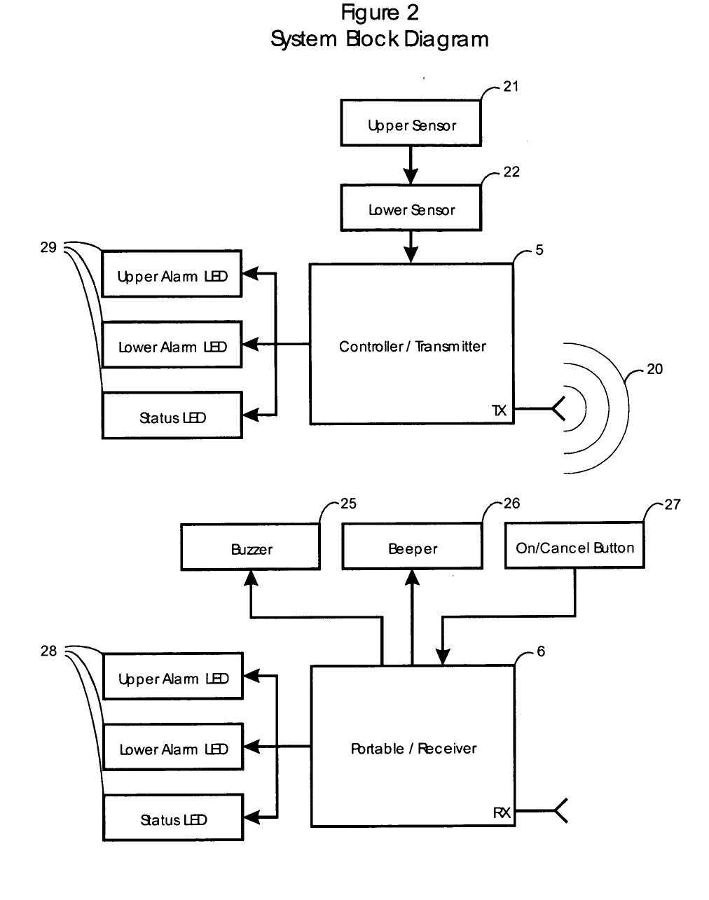

FIG. 2 describes a block diagram of the preferred embodiment of the grain level sensing system. The apparatus contains 8 major blocks; a plurality of sensors 3 & 4, a controller/transmitter 5, visual alarms 29 for the controller/transmitter 5, a portable/receiver 6, a control button 27 for the portable/receiver 6, tactile, audible & visual alarms 25, 26 & 28. Either sensors 21 or 22, detects the presence of granular material and sends an electrical signal to the controller/transmitter 5. The controller/transmitter 5 turns on the appropriate visual alarm 29 and send an encoded radio signal 27 to the portable/receiver 6. The portable/receiver 6 turns on the appropriate tactile, audible and visual alarm 25, 26, and 28 thus warning the operator who acknowledges the alarm by pressing the control button 27.

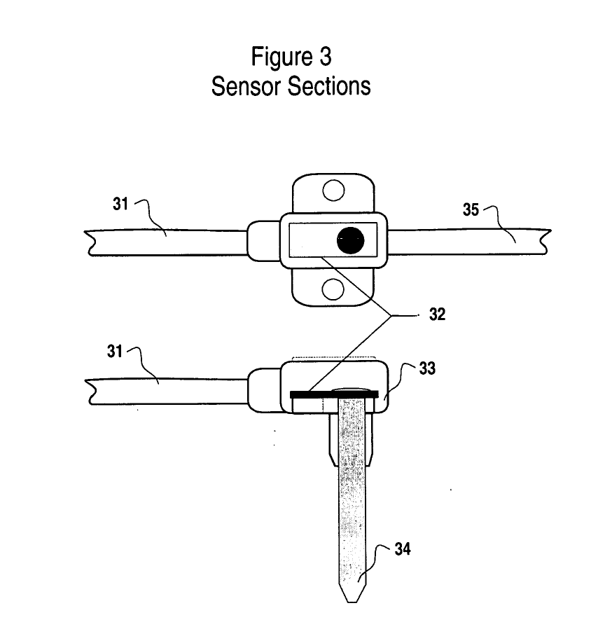

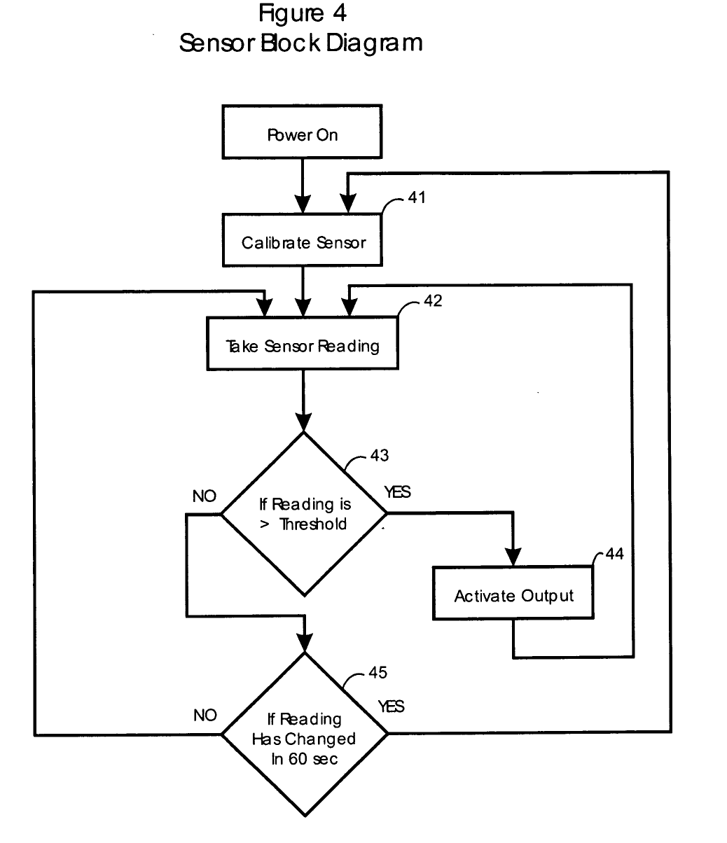

FIG. 3 describes fragmentary, sections of the preferred embodiment of the capacitive proximity sensor 3 or 4. A cable 31 is molded into a solid potted housing 33. The housing 33 encapsulates circuits 32 which implements the logic described in FIG. 4 and a metallic probe 34. The capacitance of the probe 34 changes dramatically when it becomes immersed in granular material, thus triggering the logic to send an electrical signal to the controller/transmitter via the cable 31. The cable 31 also delivers the necessary electrical power and ground to the circuits. In the case of more then one sensor, the cable 31 continues 35 out the opposite side of the housing and connects to the next sensor.

FIG. 4, describes the data flow within a prototypical sensor apparatus 3 or 4. The apparatus contains 5 major blocks: calibration 41, measurement 42, test for change 43, activate signal 44, and check if calibration required 45. On power up or periodically as determined by the logic in block 45, the sensor is calibrated 41 by adjusting its zero point to the current capacitance reading. The sensor then enters a loop which measures 32 the capacitance of the metallic probe, 34. This measurement is checked to determine if it exceeds a fixed threshold 43. If it does exceed the threshold the sensor activates 44 an electrical output signal and returns to the head of the loop 42. If it does not exceed the threshold, the sensor checks to determine if the reading has changed in the last 60 seconds 45. If it has changed the sensor is recalibrated 41. If not, the logic returns to the head of the loop 42. This loop is repeated continuously until the power is removed.

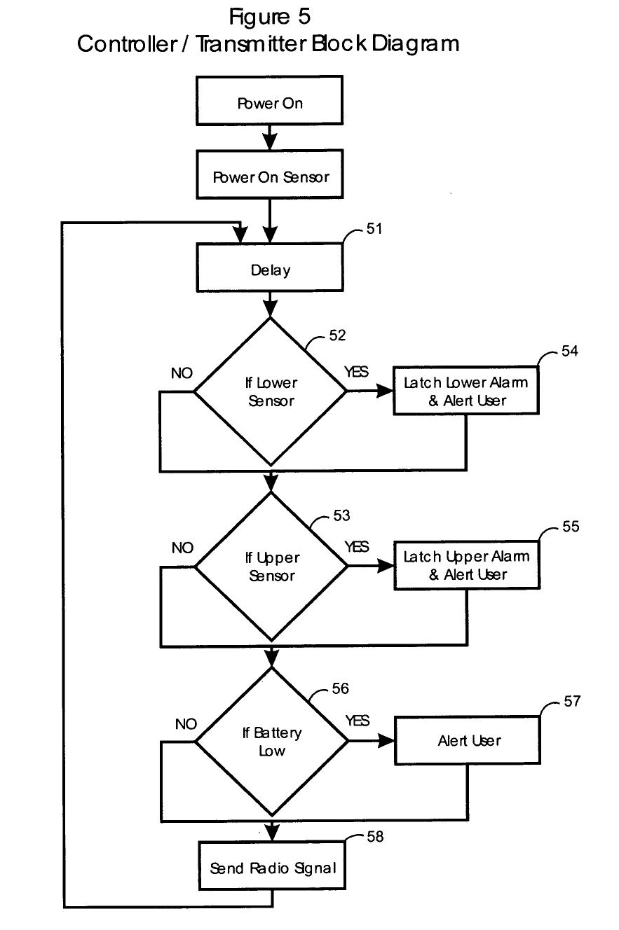

FIG. 5, describes the data flow within a prototypical controller/transmitter apparatus 55. The apparatus contains 8 major blocks; a delay timer 51, a test for the lower sensor signal 52, lower alarm control 54, a test for the upper sensor signal 3, upper alarm control 55, test for low battery voltage 56, low battery alarm 57, and a radio signal control 58.

On power on, the apparatus directs power through a cable to the sensors 3 & 4 and enters a delay timer 51. A test, alarm, and signal loop 51 to 58 is then executed periodically when the timer elapses. This loop tests 52 for an electrical signal from the lower sensor which is on if it has detected the presence of granular material, a visual alarm indicator is latched on, a flag is set 54 and control passes to the test for the upper sensor 53. If not, a test 53 is made for an electrical signal from the upper sensor which is on if it has detected the presence of granular material, a visual alarm indicator is latched on, a flag is set 55 and control passes to the test for the low battery 56. If not, the battery voltage is measured 56 and if it is below a fixed threshold, a visual alarm indicator is latched 57 on and control passes to the test radio control logic 58. If not, A radio signal encoded with the status is sent 58 to the portable/receiver 6. If the upper alarm flag is set an upper alarm signal is sent via the radio 58 to the portable/receiver 6 or if the lower alarm flag is set a lower alarm signal is sent via the radio 58 to the portable/receiver 6 or if no alarm flag, are set a no-alarm signal is sent via the radio 58 to the portable/receiver 6. Then the control passed back to the delay timer 51.

If more then 2 sensors are incorporated into the system, duplicates of logic blocks 53 & 55 are inserted between blocks 53 & 55 and the battery test 56.

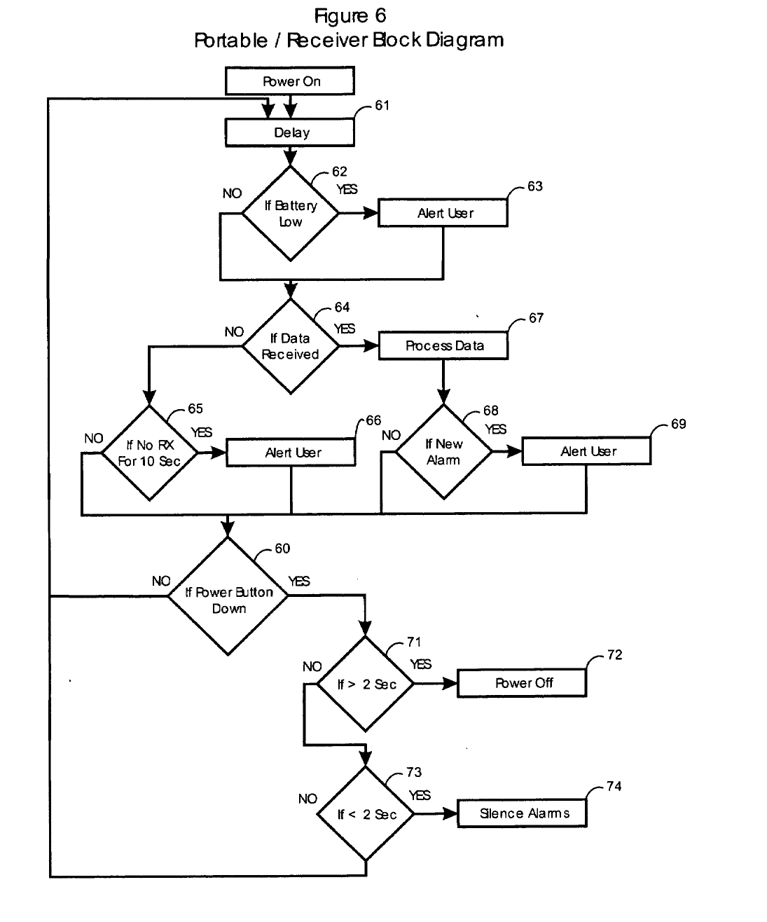

FIG. 6, describes the data flow within a prototypical portable/receiver apparatus 6. The apparatus contains 6 major blocks: a delay timer 61, a low battery test 62, a data receiver 64, a test for no communications 65, a test for new alarm 68, a test for control button status 70.

On power on, the logic starts a delay timer 61. When the timer elapses, the logic tests for low battery voltage 62. If the battery voltage is below a fixed threshold, a visual alarm indicator is latched on 63 and control passes to the data receiver 64. If not, control passes to the data receiver 64. If data has been received, the data is processed 67 ie: decoded and checked if it is valid data. Then the processed data is checked 68 to determine if it represents a new status. If it is a change in status, change 69 the audible, visual and/or tactile alarm indicator states, then the control button is checked 60. If not, check the control button 60. If no data is received, check if radio data has been received in the past 10 seconds 65. If no data has been received for 10 seconds ie: loss of communication, a visual, audible and tactile alarm indicators are latched on 66 and control passes to the control button test 60. If it has been received, then the control button is checked 60.

If the control button is pressed continuously for more then 2 seconds 71, then the power is turned off 72. If the button pressed for less then 2 seconds 73, then any audible and/or tactile alarm indicators are tuned off 74, the timer is reset 61 and the loop starts over. If the control button is not pressed the timer is reset 61 and the loop starts over.

What is claimed is:

1. Apparatus to sense the presence of granular material in a bin, comprising:
a plurality of capacitive proximity sensors, that are regularly self calibrated and control circuits to announce the detected granular material levels to an operator.

2. The apparatus as described in claim 1 further comprising:
a radio frequency transmitting device and
a radio frequency receiving device at a remote location.

3. The apparatus as described in claim 2 wherein energizing of the sensors is accomplished by the transmitter circuits.

4. The apparatus as described in claim 1 wherein the control and annunciation circuits are easily removable from the sensors.

5. The apparatus as described in claim 2 wherein the radio transmitter circuits are easily removable from the sensors.

6. The apparatus as described in claim 2 wherein the radio frequency receiving device at a remote location is a pager like device.

7. The apparatus as described in claim 2 wherein the radio signal is encoded to carry a plurality of types of alarms.

8. The apparatus as described in claim 2 wherein the circuits at the remote location occasionally checks to determine if it has adequate communication with the transmitter.

9. The apparatus as described in claim 2 wherein the circuits at the remote location provide audible, tactile, or visual annunciations or any combination thereof.

10. The apparatus as described in claim 1 wherein a plurality of circuits implementing the capacitive sensing algorithm are encapsulated together with a plurality of cables and a plurality of metallic probes.

11. The apparatus as described in claim 10 further comprising an isolative shoulder that is arranged around the metallic probes so that they can be inserted through the side of a metallic bin wall without making electrical contact with wall.

12. The apparatus as described in claim 2 wherein connecting the transmitter to the sensors automatically powers on the transmitter.

13. The apparatus as described in claim 5 wherein connecting the transmitter to the sensors automatically powers on the transmitter.
